(19) United States
(12) Patent Application Publication
(10) Pub. No.: US 2006/0076846 A1
(43) Pub. Date: Apr. 13, 2006

(54) Outer rotor type motor and drum type washing machine including same

(75) Inventor: Man Seung Han, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/245,158

(22) Filed: Oct. 7, 2005

(30) Foreign Application Priority Data
Oct. 8, 2004 (KR) 10-2004-0080256
Oct. 8, 2004 (KR) 10-2004-0080258

(51) Int. Cl. H02K 5/00

(52) U.S. Cl. 310/91

(57) ABSTRACT

An outer rotor type motor includes a rotor housing having a bottom portion and a sidewall upwardly extending from and an outer peripheral edge of the bottom portion, and a shaft bushing having a base and a hollow shaft-insertion portion provided at a center of the base. The base of the shaft bushing is coupled at the bottom portion of the rotor housing by an insert molding. A driving shaft is fitted in the shaft-insertion portion of the shaft bushing. A plurality of blade holes are circumferentially formed in the bottom portion of the rotor housing, and a plurality of blades are formed by an insert molding such that the blades are disposed at one edges of the respective blade holes in the bottom portion along a radial direction.

### FIELD OF THE INVENTION

The present invention relates to an outer rotor type motor; and, more particularly, to an outer rotor type motor capable of reducing an operation manhour by way of coupling a shaft bushing to a rotor housing through an insert molding and also firmly transmitting a rotational force by way of forming serration at coupling parts of a shaft and the shaft bushing, and a drum type washing machine including same.

### BACKGROUND OF THE INVENTION

Generally, a motor is classified into an AC motor and a DC motor, wherein the AC motor includes an induction motor.

The induction motor can be variously designed as a single phase induction motor, a three phase induction motor, a three phase wound induction motor or the like. Since the induction motor is easily usable among the AC motor, it has been widely used in household electronics.

Such induction motor is suitable for a driving motor since it exhibits a constant rotational speed depending on a load and has a long lifespan.

The aforementioned induction motor basically includes a housing; a stator fixed to the housing, for generating an induced magnetism with a power applied from an outside through a wound coil; and a rotor rotating with a driving shaft rotatably mounted at the housing via bearings by the induced magnetism generated from the stator.

In the induction motor, the rotor is rotated by a rotational force generated by an interaction between a current induced in a second coil and a rotating magnetic field, the current being induced by an electromagnetic induction of a first coil connected to a power supply. The induction motor is classified into an inner rotor type and an outer rotor type depending on a relative position between the rotor and the stator.

Recently, there is widely used the outer rotor type induction motor in which the rotor is provided at an outside of the stator to increase a torque in a same volume and an inner space of the stator can be utilized for other purposes.

FIG. 1 shows a rotor of a conventional outer rotor type induction motor.

The rotor illustrated in FIG. 1 includes a press-machined rotor made of steel, for forming an exterior of a motor; a rotor core 2 having a laminated iron core 2a press-fitted into an inner peripheral surface of the rotor 1 and ring-shaped ending members 2b respectively provided at a top and a bottom end of the laminated iron core 2a; and a shaft bushing 3 for coupling the rotor 1 and a driving shaft (not shown).

The rotating rotor 1 uses the shaft bushing 3 to transmit a rotational force to a driving shaft, wherein FIG. 2 illustrates the coupling between the rotor 1 and the shaft bushing 3.

Referring to FIG. 2, after a driving shaft 4 is inserted into a central hole of the shaft bushing 3, the driving shaft 4 and the shaft bushing 3 are fixed to each other by a bolt 6. The shaft bushing 3 is installed at a bottom portion of the rotor 1 such that fixing protrusions 7 thereof are inserted into respective holes formed in the bottom portion of the rotor 1 and the shaft bushing 3 is then fixed to the rotor 1 by an additional bolt 8.

In the conventional outer rotor type induction motor, since the shaft bushing 3 and the rotor 1 are coupled by the bolt 8, a process for tightening the bolt is required. Further, in case the bolt 6 for coupling the driving shaft 4 to the shaft bushing 3 is loosened, a slip occurs between the bushing 3 and the driving shaft 4, thereby deteriorating rotational force transmission efficiency.

### SUMMARY OF THE INVENTION

It is, therefore, an object of the present invention to provide an outer rotor type motor capable of reducing an operation manhour by way of coupling a shaft bushing to a rotor housing through an insert molding and also transmitting a rotational force by way of forming serration at coupling parts of a shaft and the shaft bushing without deteriorating the rotational force transmission efficiency.

In accordance with one aspect of the present invention, there is provided an outer rotor type motor including: a rotor housing having a bottom portion and a sidewall upwardly extending from and an outer peripheral edge of the bottom portion; a plurality of permanent magnets attached to an inner surface of the sidewall of the rotor housing; a shaft bushing having a base and a hollow shaft-insertion portion provided at a center of the base, the base being coupled at the bottom portion of the rotor housing by an insert molding; and a driving shaft fitted in the shaft-insertion portion of the shaft bushing.

Preferably, serration is formed on an inner peripheral surface of the shaft-insertion portion, and serration corresponding thereto is formed on an outer peripheral surface of an end portion of the driving shaft.

Preferably, a plurality of reinforcing ribs are circumferentially provided at an outer peripheral portion of the shaft-insertion portion of the shaft bushing.

Preferably, a plurality of blade holes are circumferentially formed in the bottom portion of the rotor housing, and a blade plate on which a plurality of blades are attached is coupled to the bottom portion such that the blades are inserted into the respective blade holes in the bottom portion. In this case, it is preferable that the blade plate and the blades are formed by an insert molding.

Alternatively, a plurality of blade holes may be circumferentially formed in the bottom portion of the rotor housing, and a plurality of blades may be formed by an insert molding such that the blades are disposed at one edges of the respective blade holes in the bottom portion along a radial direction.

In accordance with one aspect of the present invention, there is provided a drum type washing machine including the outer rotor type motor described above.

### BRIEF DESCRIPTION OF THE DRAWINGS

The above and other objects and features of the present invention will become apparent from the following description of preferred embodiments, given in conjunction with the accompanying drawings, in which:

FIG. 1 shows an exploded perspective view of a rotor of a conventional outer rotor type motor;

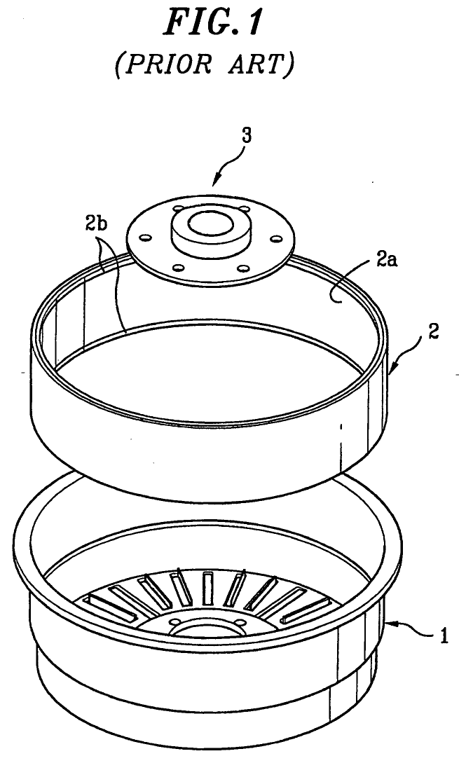

FIG. 2 describes a sectional view illustrating a state where a driving shaft is coupled to a shaft bushing of FIG. 1;

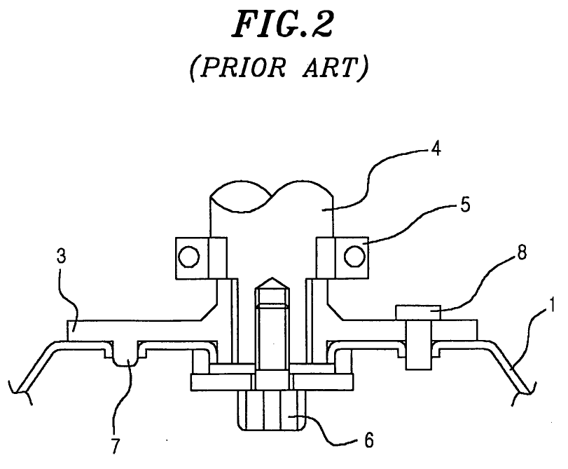

FIG. 3 provides an exploded perspective view of a rotor of an outer rotor type motor in accordance with a preferred embodiment of the present invention;

FIG. 4 represents a sectional view of a driving unit of a drum type washing machine having the outer rotor type motor in accordance with the preferred embodiment of the present invention;

FIG. 5 offers a fragmentary exploded sectional view depicting principal parts of FIG. 4;

FIG. 6 presents an exploded perspective view of a rotor of an outer rotor type motor in accordance with a modified embodiment of the present invention; and

FIG. 7 depicts a sectional view showing a state where the outer rotor type motor in accordance with the modified embodiment of the present invention is installed in a drum type washing machine.

### DETAILED DESCRIPTION OF THE PREFERRED EMBODIMENT

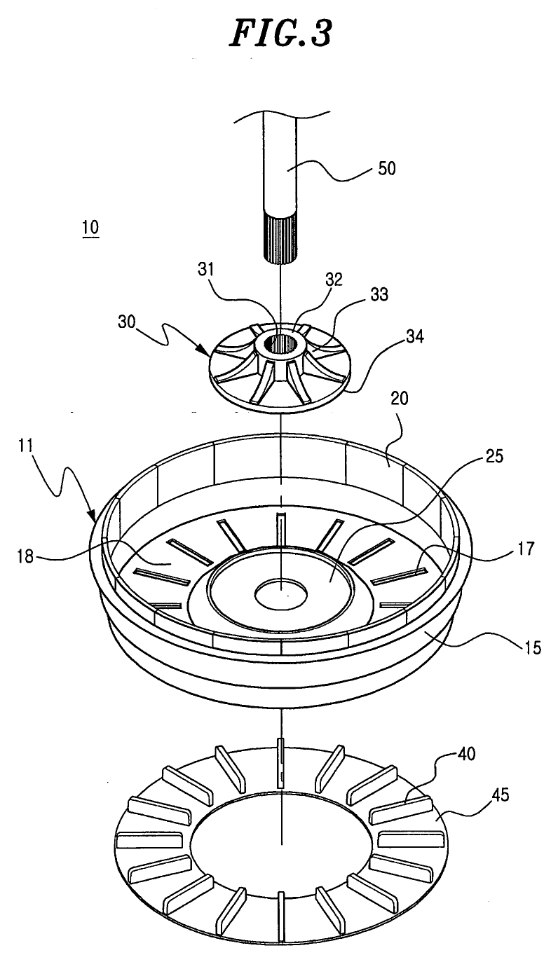

Hereinafter, an outer rotor type motor in accordance with a preferred embodiment of the present invention will be described with reference to FIGS. 3 to 5.

FIG. 3 shows an exploded perspective view of a rotor 10 of the outer rotor type motor of the present invention. Referring to FIG. 3, the rotor 10 includes a rotor housing 11; a shaft bushing 30 coupled at a center of a bottom portion 18 of the rotor housing; and a disc-shaped blade plate 45 on which blades 40 are arranged in a circumferential direction.

The rotor housing 11 made of, e.g., steel has bottom portion 18 and a cylindrical sidewall 15 upwardly extending from an outer peripheral edge of the bottom portion 18. Provided at the center of the bottom portion 18 is a shaft bushing coupling section 25 at which the shaft bushing is coupled. The shaft bushing coupling section 25 has a central hole through which a driving shaft 50 penetrates. Formed in the bottom portion 18 of the rotor housing 11 is a plurality of blade holes 17 arranged in a circumferential direction. A plurality of permanent magnets 20 are circumferentially attached to an inner surface of the sidewall 15.

The shaft bushing 30 includes a base 34 and a hollow shaft-insertion portion 32 provided at a center of the base 34. The base 34 of the shaft bushing 30 is coupled to the shaft busing coupling section 25 of the rotor housing 11 by an insert molding. Therefore, a conventional tightening process for a bolt is eliminated. Serration 31 is formed on an inner peripheral surface of the shaft-insertion portion 32. And also, serration 51 corresponding thereto is formed at an outer peripheral surface of an end portion of the driving shaft 50. Accordingly, the serration 31 of the inner peripheral surface of the shaft-insertion portion 32 and the serration 51 of the driving shaft 50 are engaged with each other to thereby prevent a slippage between the driving shaft 50 and the shaft bushing 30 and a deterioration of the rotational force transmission efficiency. Moreover, a plurality of reinforcing ribs 33 are circumferentially provided at an outer peripheral portion of the shaft-insertion portion 32 for preventing the shaft-insertion portion 32 from being damaged or broken by the coupling force of the driving shaft 50 to the shaft-insertion portion 32, a rotational force transmitted from the rotor 10 to the driving shaft 50 or the like.

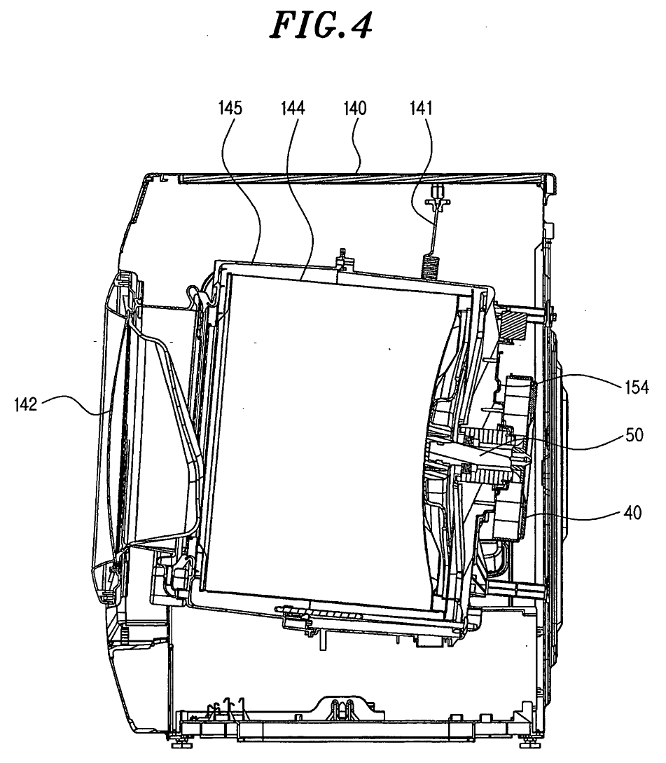

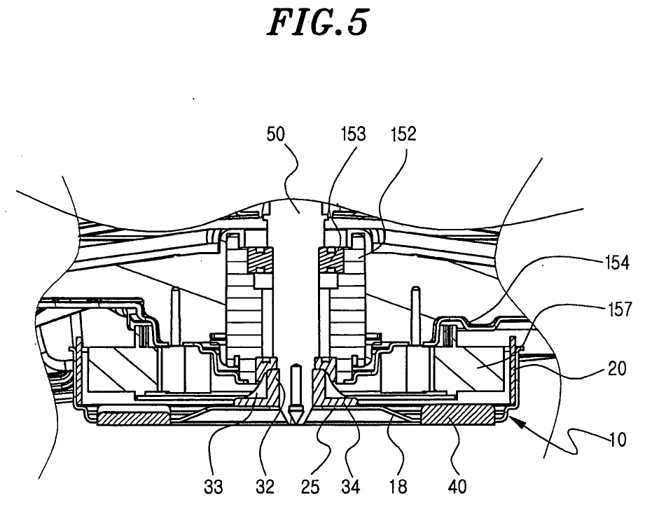

Further, the blade plate 45 is coupled to the bottom portion 18 of the rotor housing 11 such that the blades 40 are inserted into and protruded from the respective blade holes 17 in the bottom portion 18 of the rotor housing 11. In this case, it is preferable to form the blade plate 45 and the blades 40 by the insert molding. The blades 40 rotate with the rotor housing 11, thereby cooling, e.g., a coil of a stator 157 (see FIGS. 4 and 5) by pumping the air inside the rotor housing 11 toward it.

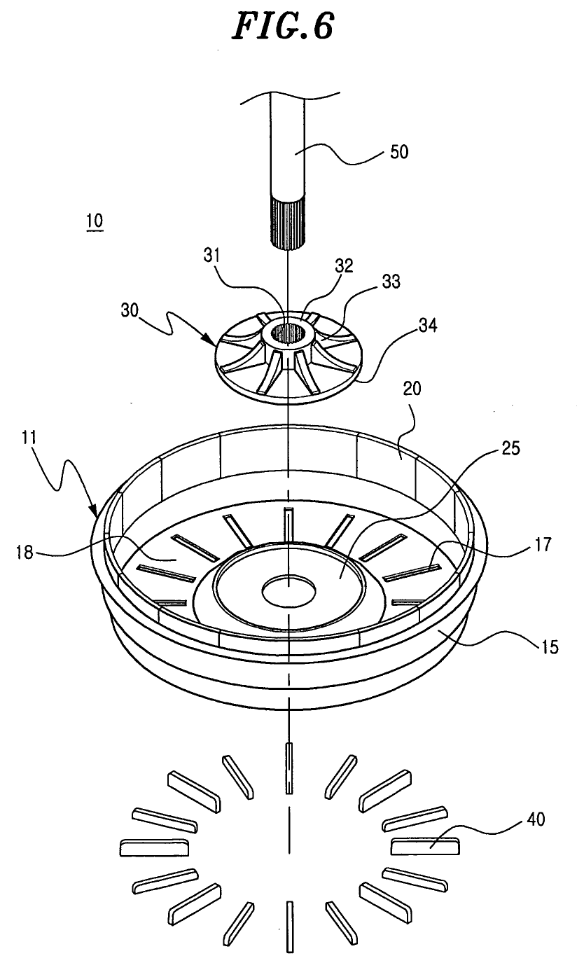

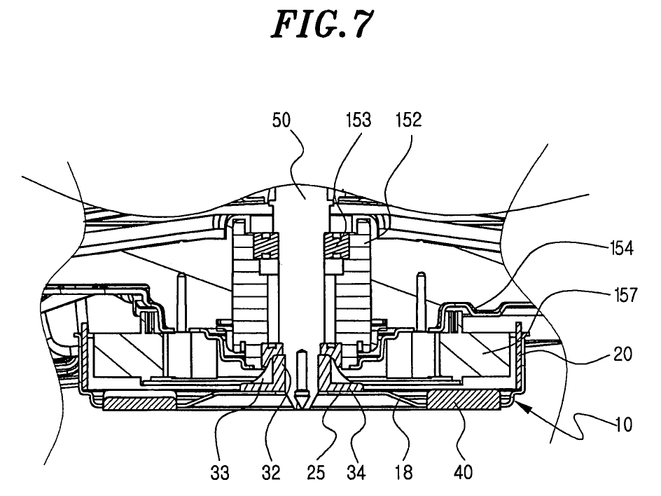

Meanwhile, as a modified embodiment of the present invention, as shown in FIGS. 6 and 7, the blades 40 themselves may be so formed as to be upwardly protruded from the blade holes 17 of the bottom portion 18 of the rotor housing 11 through the insert molding without being attached onto the blade plate 45. In this case, the blades 40 are disposed at one edge of each blade hole along a radial direction. Since the blades 40 rotate with the rotor housing 11, air is inwardly introduced from the outside of the rotor housing 11, thereby cooling the coil of the stator 157 and the like.

FIG. 4 provides a sectional view of a drum type washing machine having the outer rotor type motor in accordance with the preferred embodiment of the present invention, and FIG. 5 presents a fragmentary exploded sectional view of FIG. 4.

The outer rotor type motor is installed at a rear portion of a cabinet 140 of the drum type washing machine, and a door 142 is openably/closably installed at a front portion of the cabinet 140. A tub 145 is suspended by suspension springs 141 in the cabinet 140, and a drum 144 is rotatably installed in the tub 145. A rear end portion of the drum 144 is injection-molded as a unit with the driving shaft 50 of the motor, so that a rotational force of the motor can be transmitted to the drum 144.

The driving shaft 50 of the motor is rotatably supported by bearings 153 installed inside a bearing housing 152. Further, a rear end portion of the bearing housing 152 is fixed to a base plate 154 and isolated from the motor by the base plate 154. The base plate 154 is so installed as to surround an exterior of the bearing housing 152 and the tub 145. Further, the base plate 154 fixes the bearing housing 152 to the tub 145 and also isolates the motor from the tub 145.

The stator 157 of the motor is fixed to the base plate 154. Further, the cylindrical rotor housing 11 of the rotor 10 of the present invention is installed such that the permanent magnets 20 attached to the inner surface thereof face the stator 157.

When the rotor 10 of the motor rotates, the driving shaft 50 and the drum 144 rotate, thereby performing a desired washing function.

In accordance with an outer rotor type motor of the present invention, since the shaft bushing 30 is formed as a unit with the bottom portion 18 of the rotor housing 11 through the insert molding without using a fastening member, e.g., bolt, thereby simplifying a manufacture of the rotor of the motor. Further, by forming serration at coupling parts of the driving shaft 50 and the shaft bushing 30, the rotational force can be firmly transmitted without deteriorating the rotational force transmission efficiency. Further, in case the blades 40 are coupled to the blade holes 17 of the bottom portion 18 of the rotor housing 11 through the insert molding, a productivity of the motor is further improved.

While the invention has been shown and described with respect to the preferred embodiments, it will be understood by those skilled in the art that various changes and modification may be made without departing from the spirit and scope of the invention as defined in the following claims.

What is claimed is:

1. An outer rotor type motor comprising:
a rotor housing having a bottom portion and a sidewall upwardly extending from and an outer peripheral edge of the bottom portion;
a plurality of permanent magnets attached to an inner surface of the sidewall of the rotor housing;
a shaft bushing having a base and a hollow shaft-insertion portion provided at a center of the base, the base being coupled at the bottom portion of the rotor housing by an insert molding; and
a driving shaft fitted in the shaft-insertion portion of the shaft bushing.

2. The outer rotor type motor of claim 1, wherein serration is formed on an inner peripheral surface of the shaft-insertion portion, and serration corresponding thereto is formed on an outer peripheral surface of an end portion of the driving shaft.

3. The outer rotor type motor of claim 1, wherein a plurality of reinforcing ribs are circumferentially provided at an outer peripheral portion of the shaft-insertion portion of the shaft bushing.

4. The outer rotor type motor of claim 1, wherein a plurality of blade holes are circumferentially formed in the bottom portion of the rotor housing, and a blade plate on which a plurality of blades are attached is coupled to the bottom portion such that the blades are inserted into the respective blade holes in the bottom portion.

5. The outer rotor type motor of claim 4, wherein the blade plate and the blades are formed by an insert molding.

6. The outer rotor type motor of claim 1, wherein a plurality of blade holes are circumferentially formed in the bottom portion of the rotor housing, and a plurality of blades are formed by an insert molding such that the blades are disposed at one edges of the respective blade holes in the bottom portion along a radial direction.

7. A drum type washing machine comprising the outer rotor type motor described in claim 1.
